(19) United States
(12) Patent Application Publication
(10) Pub. No.: US 2016/0068363 A1
(43) Pub. Date: Mar. 10, 2016

(54) POST-PROCESSING APPARATUS, IMAGE FORMING SYSTEM, AND POST-PROCESSING METHOD

(71) Applicant: KONICA MINOLTA, INC., Tokyo (JP)

(72) Inventor: Tomohiro KIRIYAMA, Kofu-shi (JP)

(73) Assignee: KONICA MINOLTA, INC., Tokyo (JP)

(21) Appl. No.: 14/845,501

(22) Filed: Sep. 4, 2015

(30) Foreign Application Priority Data
Sep. 9, 2014 (JP) 2014-183702

(51) Int. Cl. B65H 37/04; B42B 2/02; B65H 37/06; B42C 1/12

(52) U.S. Cl. CPC B65H 37/04; B42C 1/12; B42B 2/02; B65H 37/06

(57) ABSTRACT

A post-processing apparatus includes a control unit for introducing a sheet onto an outside of a booklet saddle stitched by a saddle stitching unit so as to cover one or more binding needles before pressurizing a center portion of the saddle stitched booklet by a pressurization member, causing the pressurization member to perform pressurization processing through the sheet, and, after the pressurization processing, causing the booklet together with the sheet to be ejected to the ejection unit.

### CROSS-REFERENCE TO RELATED APPLICATION

This application is based on Japanese Patent Application No. 2014-183702 filed on Sep. 9, 2014, the contents of which are incorporated herein by reference.

### BACKGROUND

1. Technical Field

The present invention relates to a post-processing apparatus, an image forming system including the post-processing apparatus, and a post-processing method.

2. Description of Related Arts

Connecting a post-processing apparatus to an image forming apparatus allows for various kinds of book binding processing. Saddle stitching book binding is one of the various kinds of book binding processing. Saddle stitching book binding processing creates a booklet by stapling a center portion of a paper bundle composed of a plurality of stacked pieces of paper and causing the paper bundle to pass through between a pair of rollers, with the center portion thereof ahead, so as to perform half-folding processing.

Additionally, in order to improve appearance of a booklet created by saddle stitching book binding, there is a folded portion flattening apparatus (for example, Patent Literature 1: Japanese Unexamined Patent Application Publication No. 2007-99485). The folded portion flattening apparatus performs flattening processing (square spine processing) for flattening a spine of the booklet by pressing a bulging portion of a fold of the saddle stitched booklet by means of a roller running along the fold.

In the folded portion flattening apparatus disclosed in Patent Literature 1, in order to prevent a crack-like wrinkle on a paper surface occurring when performing the flattening processing while applying pressure with the roller, a sheet-like member is arranged between the fold of the booklet to which the pressure is applied and the roller. Arranging the sheet-like member allows the fold not to directly contact with the pressure applying roller, thereby preventing a wrinkle from occurring on a flattened surface of the spine of the booklet.

However, the folded portion flattening apparatus disclosed in Patent Literature 1 causes the sheet-like member, instead of the pressure applying roller, to contact with the fold. When a contaminant sticks to the sheet-like member, the contaminant can transfer onto a next booklet that will be subjected to flattening processing, which can thus reduce quality of the booklet.

The present invention has been accomplished in view of the above circumstances, and it is an object of the invention to provide a post-processing apparatus that can create a booklet without reducing quality.

### SUMMARY

To achieve the aforementioned object, a post-processing apparatus reflecting one aspect of the present invention comprises:

a conveyance unit for conveying paper conveyed from an image forming apparatus;

a paper stacking unit for stacking a plurality of pieces of paper;

a saddle stitching unit for saddle stitching a center portion of the plurality of pieces of paper stacked by the paper stacking unit by one or more binding needles to create a booklet;

a pressurization unit provided with a pressurization member, the pressurization unit performing pressurization processing on the booklet by pressurizing the center portion of the booklet saddle stitched by the saddle stitching unit by the pressurization member;

an ejection unit for ejecting the booklet subjected to the pressurization processing by the pressurization unit; and

a control unit for introducing a sheet onto an outside of the saddle stitched booklet so as to cover the one or more binding needles before pressurizing by the pressurization member, causing the pressurization member to perform the pressurization processing through the sheet, and, after the pressurization processing, causing the booklet together with the sheet to be ejected to the ejection unit.

### BRIEF DESCRIPTION OF THE DRAWINGS

FIG. 1 is an overall view showing a schematic structure of an image forming system 10 according to a first embodiment of the present invention.

FIG. 2 is a block diagram showing a main structure of the image forming system 10.

FIG. 3 is a perspective view showing an appearance of a saddle stitching apparatus 300.

FIG. 4 is a perspective view showing a schematic structure of the saddle stitching apparatus 300.

FIG. 5 is a perspective view showing a main structure of a square spine shaping unit 360.

FIGS. 6A and 6B are schematic diagrams illustrating square spine processing (pressurization processing) by a pressurization roller 361 (a pressurization unit).

FIGS. 7A to 7D are schematic diagrams illustrating changes in states of a booklet b and a sheet 500 before and after the square spine processing.

FIG. 8 is a flowchart regarding booklet creation executed by a control unit 310.

FIG. 9 is a sub-routine of sheet introduction determination processing at a step S103 of FIG. 8.

FIGS. 10A to 10D are schematic diagrams of the booklet b as seen from a spine b1 side.

FIGS. 11A to 11D are schematic diagrams of the booklet b as seen from a top side (an upper direction).

FIG. 12 is a schematic diagram showing a structure of a saddle stitching apparatus 400 in a second embodiment of the invention.

FIGS. 13A to 13C are schematic diagrams illustrating middle folding processing (pressurization processing) by folding rollers 431 (a pressurization unit).

### DETAILED DESCRIPTION

Hereinafter, exemplary embodiments of the present invention will be described with reference to the accompanying drawings. In the description of the drawings, the same elements are denoted by the same reference signs and overlapping description thereof will be omitted. In addition, dimensional ratios in the drawings are exaggerated for descriptive convenience and may be different from actual ratios.

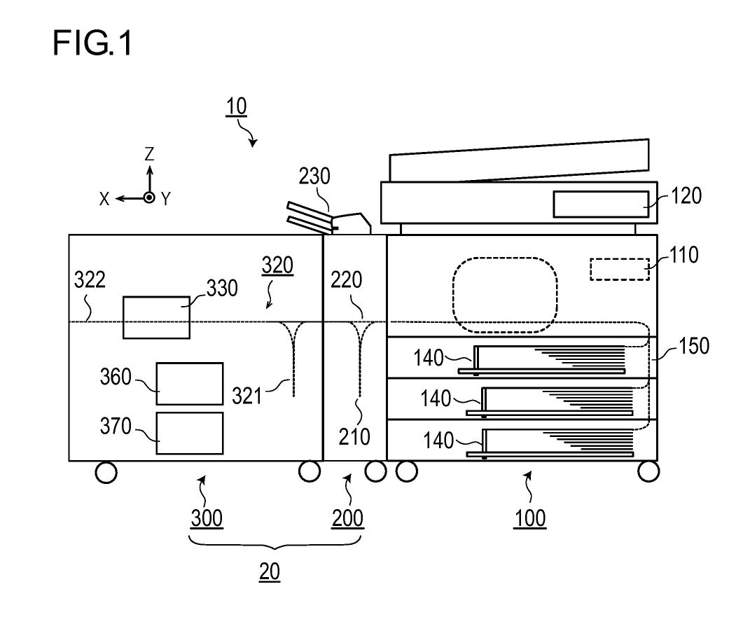

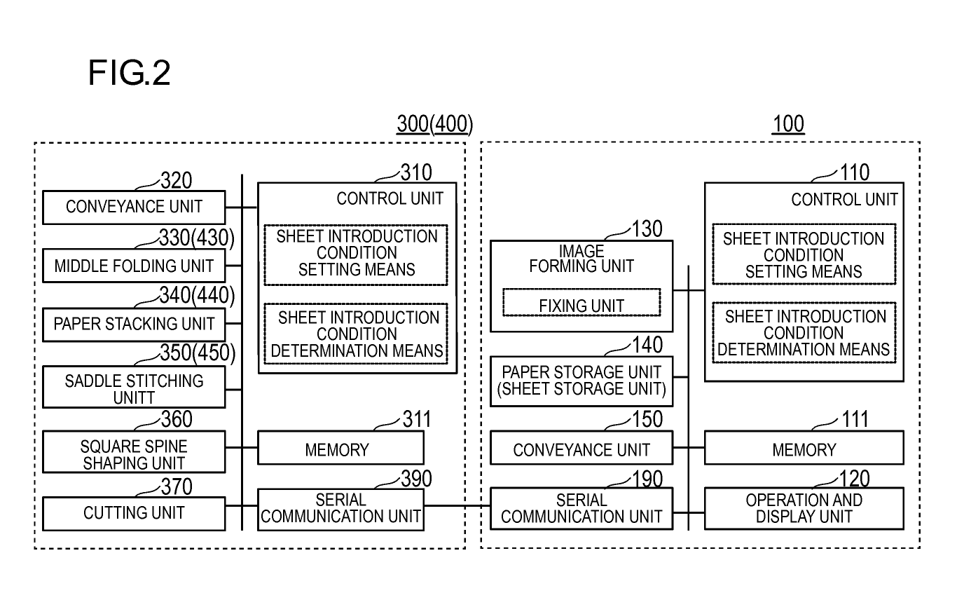

FIG. 1 is an overall view showing a schematic structure of an image forming system 10 according to a first embodiment of the present invention. FIG. 2 is a block diagram showing a main structure of the image forming system 10.

As shown in FIGS. 1 and 2, the image forming system 10 includes an image forming apparatus 100 and a post-processing apparatus 20 connected thereto. The post-processing apparatus 20 includes a reverse conveyance apparatus 200 and a saddle stitching apparatus 300.

The image forming apparatus 100 includes a control unit 110, a memory 111, an operation and display unit 120, an image forming unit 130, a plurality of paper storage units 140, a conveyance unit 150, and a serial communication unit 190. The control unit 110 is provided with a CPU, a RAM, and a ROM thereinside, and executes various kinds of controls by causing the CPU to develop programs stored in the ROM or the memory 111 into the RAM and execute the programs. The ROM stores values for setting image forming conditions corresponding to type and weight of paper, functions executable by the post-processing apparatus, and conditions settable thereby. The memory 111 comprises a semiconductor memory, an HDD, and the like and stores image data, various kinds of setting data, and the like.

The operation and display unit 120 comprises, for example, a touch panel or the like formed by mounting a touch sensor on a liquid crystal display. The operation and display unit 120 displays a state of the image forming system to a user and/or receives a setting input, a printing instruction, or the like from the user. The setting data stored in the memory 111 includes a type and a weight value of paper stored in each of the paper storage units 140. The user can set each type and weight value of the paper through the operation and display unit 120.

The image forming unit 130 forms an image on paper, for example, by an electrophotographic system. The image forming unit 130 includes a fixing unit provided with a heater thereinside to fix a toner image by heating and pressurizing the toner image transferred onto paper by the fixing unit. Setting of a fixing control temperature is changed on the basis of information of the type and weight of paper. The conveyance unit 150 includes a plurality of pairs of conveyance rollers and a drive motor (both of which are not shown), and conveys paper fed from each paper storage unit 140 to the image forming unit 130 and the post-processing apparatus 20 on a further downstream side than the image forming unit 130 in a conveying direction.

The reverse conveyance apparatus 200 includes a switch-back path 210. The reverse conveyance apparatus 200, as needed, conveys paper with an image already formed thereon conveyed from the image forming apparatus 100 to the switch-back path 210, reverses a front side and a back side of the paper, and then conveys the reversed,paper to the saddle stitching apparatus 300 on the downstream side. On the other hand, paper whose front side and back side do not need to be reversed is caused to pass through a bypass path 220 to be conveyed, as it is, to the saddle stitching apparatus 300. The reverse conveyance apparatus 200 also includes a paper placement unit 230 so as to be able to store front cover paper and a sheet 500 for preventing contamination in forming a booklet, and conveys the front cover paper and the sheet 500 stored according to setting to the saddle stitching apparatus 300 on the downstream side. Details of the sheet 500 will be described later.

### (Saddle Stitching Apparatus 300)

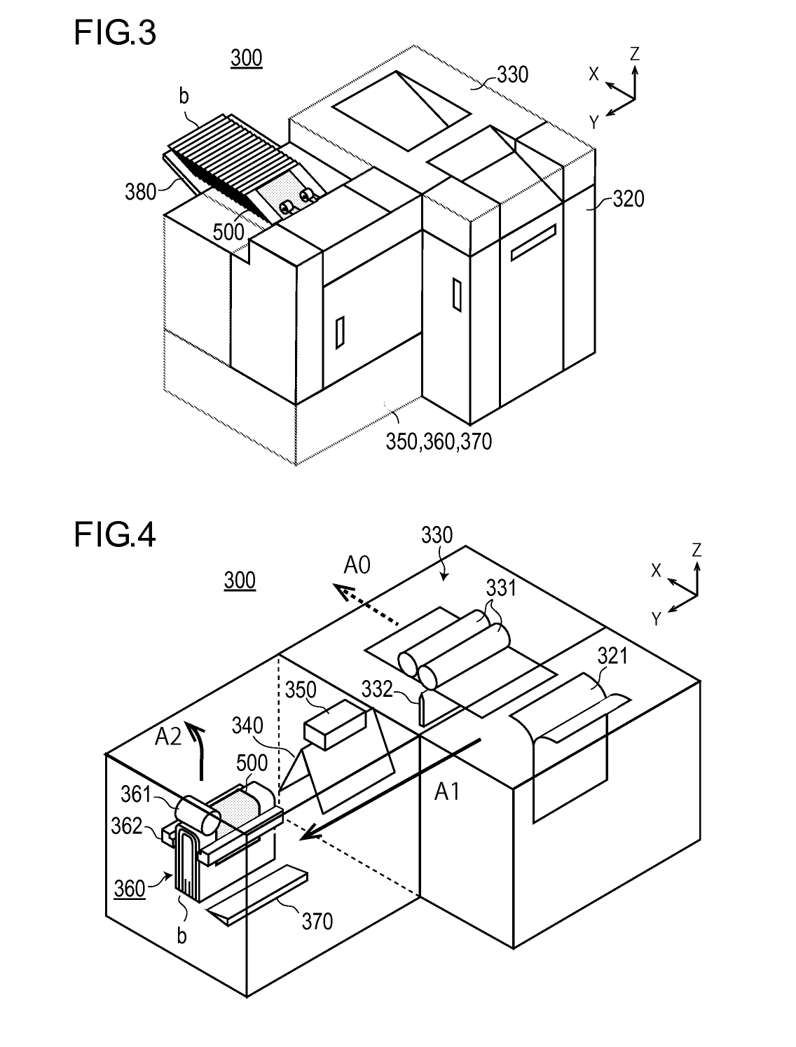

FIG. 3 is a perspective view showing an appearance of the saddle stitching apparatus 300. FIG. 4 is a perspective view showing an outline of the saddle stitching apparatus 300.

As shown in FIGS. 1 to 4, the saddle stitching apparatus 300 includes a control unit 310, a memory 311, a conveyance unit 320, a middle folding unit 330, a paper stacking unit 340, a saddle stitching unit 350, a square spine shaping unit 360, a cutting unit 370, an ejection unit 380 (see FIG. 3), and a serial communication unit 390.

The control unit 310 is provided with a CPU, a RAM, and a ROM thereinside, and executes various kinds of controls regarding the post-processing apparatus 20 by causing the CPU to develop programs stored in the ROM or the memory 311 into the RAM and execute the programs. The ROM stores various kinds of programs for functioning as a sheet introduction condition setting means, a sheet introduction condition determination means, and the like, which will be described later. The memory 311 comprises a semiconductor memory, an HDD, and the like, and stores various kinds of setting data and the like. The setting data includes sheet introduction conditions, which will be described later. The serial communication unit 390 receives and transmits various kinds of signals necessary to control setting values and operation timings, and the like, from and to the serial communication unit 190 of the image forming apparatus 100.

The conveyance unit 320 includes a plurality of pairs of conveyance rollers and a drive motor (both of which are not shown) to convey paper from the image forming apparatus 100 or the reverse conveyance apparatus 200 or eject a booklet created from the paper to the ejection unit 380. In addition, the conveyance unit 320 includes a reversing and stacking conveyance path 321 to temporarily place one piece or a plurality of pieces of paper thereon and perform crease forming processing (creasing) on the placed paper or cutting processing on leading and trailing ends of the paper in a paper conveying direction. According to setting, the conveyance unit 320 can cause the paper to be conveyed, as it is, without the processing by the saddle stitching apparatus 300 on the paper, through a conveyance path 322 on the downstream side in a paper conveying direction (X direction) and ejected outside the apparatus (an arrow A0 in FIG. 4).

As shown in FIG. 4, the middle folding unit 330 is arranged on the downstream side of the reversing and stacking conveyance path 321. The middle folding unit 330 performs middle folding processing on one piece of paper or a plurality of pieces of paper stacked together and conveyed from the reversing and stacking conveyance path 321. The middle folding unit 330 includes a pair of folding rollers 331 and a folding blade 332. The folding blade 332 is a plate-shaped member extending on a Y-Z plane. The middle folding unit 330 temporarily stops the conveyed paper so that a center portion of the conveyed paper in the conveying direction (X direction) is positioned right under a nip portion of the folding rollers 331, and then, causes the folding blade 332 to be protruded to the center portion of the stopped paper from downward to upward (Z direction). This allows the paper to pass through between the rotating folding rollers 331, with the center portion thereof ahead. Through such a procedure, middle folding processing is performed to form a fold at the center portion of the paper.

After that, retracting the folding blade 332 to the initial position, as well as reversely rotating of the folding rollers 331,the paper subjected to middle folding processing is returned to the initial temporary stop position. Then, the paper is conveyed by the conveyance unit 320 in a direction perpendicular to the previous conveying direction (Y direction indicated by an arrow A1) to be placed and stacked on the paper stacking unit 340. The paper stacking unit 340 includes an upwardly convex saddle-shaped placement surface. The plurality of pieces of paper middle folded by the middle folding unit 330 are placed in such a mountain fold shape that a fold is positioned upward and fore edges at both ends are positioned downward along the placement surface of the paper stacking unit 340.

The saddle stitching unit 350 includes a needle driving mechanism and a needle receiving mechanism. The needle receiving mechanism is disposed near an apex of the saddle-shaped placement surface. The needle driving mechanism is disposed right above the needle receiving mechanism. After pieces of paper corresponding to one booklet are stacked on the placement surface of the paper stacking unit 340, the needle driving mechanism descends to drive a binding needle into one or more predetermined positions along the fold of the center portion of the paper bundle. A position for binding may be one position at the center or may include a plurality of positions distributed equally from the center, according to setting. The needle driving mechanism may be arranged in a number corresponding to a number of the binding positions, or one needle driving mechanism may be configured to move along the fold (Y direction). In this manner, a booklet b is created by performing the middle folding processing and the saddle stitching processing.

The booklet b obtained after the processing by the saddle stitching unit 350 is conveyed to the square spine shaping unit 360 and the cutting unit 370 on a further downstream side in the Y direction (the arrow A1) by the conveyance unit 320. Then, according to setting, the booklet b is subjected to pressurization processing (hereinafter referred to also as “square spine processing”) for flattening a bulging portion of the spine (spine cover) of the middle folded booklet b by the square spine shaping unit 360 and cutting processing for straightly aligning the fore edges of the booklet b by the cutting unit 370. After that, the booklet b is ejected to the ejection unit 380 (an arrow A2). Hereinafter, a detailed description will be given of the square spine processing by the square spine shaping unit 360.

### (Square Spine Shaping Unit 360)

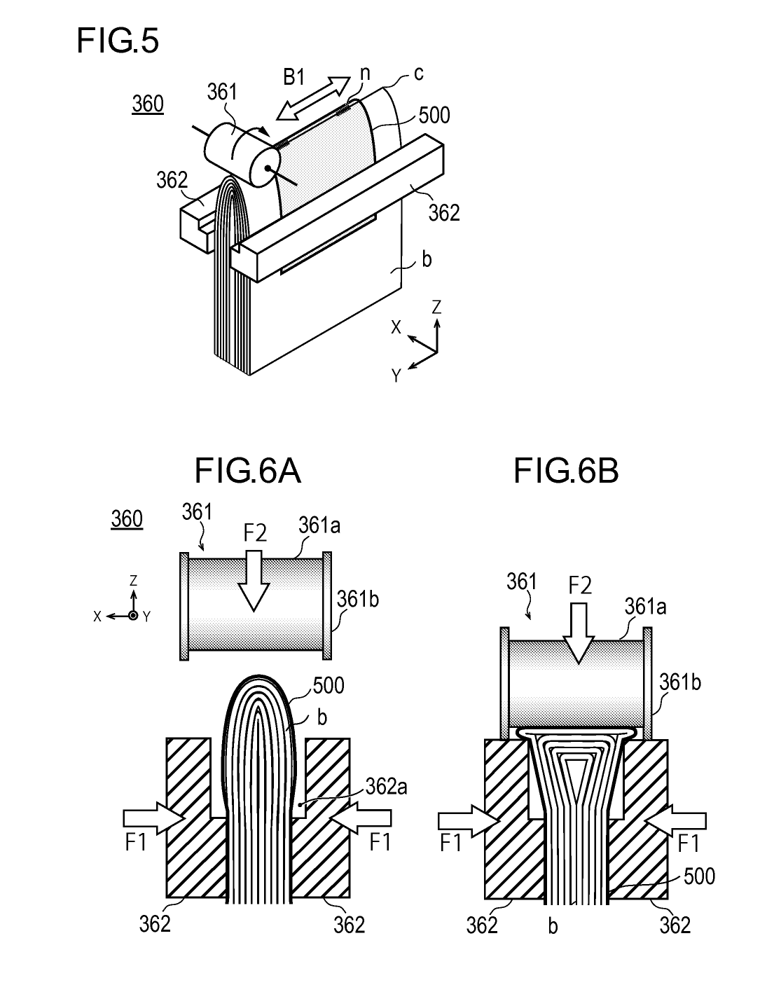

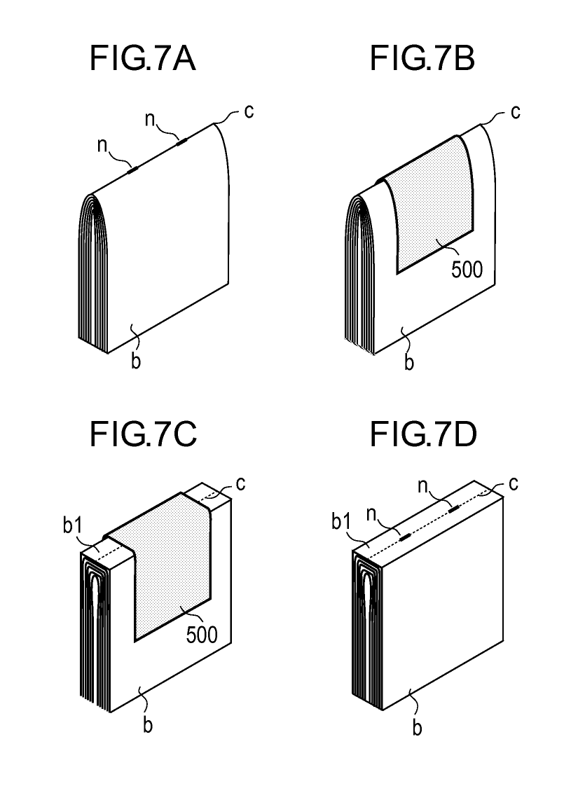

FIG. 5 is a perspective view showing a main structure of the square spine shaping unit 360. FIGS. 6A and 6B are diagrams of the main structure as seen from the Y direction, which are schematic diagrams illustrating square spine processing by the pressurization roller 361. FIGS. 7A to 7D are schematic diagrams illustrating changes in states of the booklet b and the sheet 500 before and after the square spine processing.

As shown in FIG. 5, FIGS. 6A and 6B, and the like, the square spine shaping unit 360 includes the pressurization roller 361 and a pair of clamping members 362. In the present embodiment, the square spine shaping unit 360 functions as a “pressurization unit”, and the pressurization roller 361 functions as a “pressurization member”.

As shown in FIG. 5 and FIGS. 6A and 6B, the pair of clamping members 362 move from both sides in a direction perpendicular to a front cover surface of the booklet b (X direction). The clamping members 362 moved as shown in FIGS. 6A and 6B clamp portions near the fold of the front cover surface of the booklet b from both sides with each clamping force F1. Then, as shown in FIG. 6A, while the booklet b is being clamped by the clamping members 362, the fold (a center portion c of the paper) is pressurized with a shaping pressure F2 from a Z direction parallel to clamping faces (Y-Z plane) by the pressurization roller 361. While being caused to pressurize as shown in FIG. 6B, the pressurization roller 361 is rotationally moved in the Y direction (an arrow B1 in FIG. 5) along the fold (the center portion c of the paper) of the booklet b, thereby performing square spine processing for flatly shaping the spine b1. A number of times of movement for moving the pressurization roller 361 back and forth in the Y direction, that is, the number of times of reciprocation may be set according to the number of pieces, thickness, and type of paper forming the booklet b or may be set to a predetermined number of times by a setting made by the user.

A top surface of each of the clamping members 362 is a flat surface extending horizontally (a X-Y plane), and a recess portion 362a is provided inside an upper part thereof. In addition, the pressurization roller 361 comprises a cylindrical roller main body 361a that comes in contact with the booklet b and disk-shaped flange portions 361b each concentrically provided on both outsides of the main body 361a. A material of the roller main body 361a can be a metal, a rubber having high hardness, or a resin. In addition, the pressurization roller 361 rotationally moves in a state where the flange portions 361b are in contact with the top surfaces of the clamping members 362. A level of strength for square spine shaping can be adjusted by appropriately setting a level difference of each recess portion 362a (a length thereof in the X direction) or a depth thereof (a length thereof in the Z direction), or a radius difference between the roller main body 361a and the flange portions 361b (a roller lifting amount). Additionally, in the present embodiment, the pressurization roller 361 is driven to rotate by movement of a rotational shaft. However, a drive motor connected to the rotational shaft may be provided so as to drive the pressurization roller 361 to rotate. Then, when driving the pressurization roller 361 to rotate, the level of strength for square spine shaping may be adjusted by changing a rotational speed.

### (Introduced Sheet 500)

FIGS. 7A to 7D are schematic diagrams illustrating states of the sheet 500 introduced onto the booklet b when performing square spine shaping by the square spine shaping unit 360.

FIG. 7A shows a state of the booklet b immediately after having been saddle stitched by the saddle stitching unit 350. In the drawing, a binding needle n is driven into two positions along the fold at the center portion c of the booklet b.

FIG. 7B is a diagram showing a state of the booklet b following FIG. 7A. The drawing shows a state of the sheet 500 introduced onto an outside of the booklet b. In the present embodiment, the sheet 500 is introduced onto the outside of the booklet b saddle stitched by one or more binding needles n in the paper stacking unit 340 so as to cover the one or more binding needles n. The sheet 500 is conveyed from the paper placement unit 230 (see FIG. 1) of the post-processing apparatus 20. The sheet 500 may be a sheet-like flexible member made of a resin material or the like or paper (plain paper). In addition, when using paper, the paper may be blank paper fed from any one of the paper storage units 140 of the image forming apparatus 100.

In the example shown in the drawing, the center portion of the sheet 500 in the conveying direction (X direction) is middle folded by the middle folding unit 330 and then conveyed to the paper stacking unit 340. Thus, the sheet 500 is mounted on the booklet b in such a state that the fold (the center portion c) of the booklet b placed on the paper stacking unit 340 and the fold of the sheet 500 conveyed later are superimposed on each other.

FIG. 7C is a diagram showing a state of the booklet b following FIG. 7B. The drawing shows a state of the booklet b after square spine shaping processing performed in the state where the sheet 500 is introduced onto the outside of the booklet b. The square spine shaping processing forms a square spine by flatly crushing the fold of the booklet b and perpendicularly bending a portion near the center portion c at two positions. As shown in the drawing, the spine b1 is formed on the booklet b subjected to the square spine shaping processing. Then, the booklet b isejected to the ejection unit 380 (see FIG. 3) in the state where the booklet b is covered with the sheet 500, as shown in FIG. 7C.

FIG. 7D is a diagram showing a state of the booklet b following FIG. 7C, where the sheet 500 that had covered the booklet b is removed by the user. The removed sheet 500 will be discarded.

Thus, in the present embodiment, the sheet 500 is introduced so as to cover the one or more binding needles n of the saddle stitched booklet b, followed by pressurization processing by the pressurization roller 361 through the sheet 500. Thereby, the binding needles n and the pressurization roller 361 do not directly contact with each other, and neither do the spine b1 of the booklet b and the pressurization roller 361.

If the sheet 500 is not used and the pressurization roller 361 and the binding needles n directly contact with each other, wrinkles can occur on the spine b1 of the booklet b. In addition, shavings of the binding needles n occurring due to contact with the pressurization roller 361 cause contamination of the booklet b or cause spread of grease stuck to the binding needles n, resulting in contamination of the booklet b. Furthermore, sliding of the pressurization roller 361 with a toner image formed near the center portion c of the booklet b causes problems such as deterioration of quality of the toner image due to scrape or contamination of the booklet b due to transfer of peeled toner to surroundings.

In the present embodiment, the sheet is introduced onto the outside of the saddle stitched booklet b so as to cover the one or more binding needles; pressurization processing is performed by the pressurization member through the sheet; and, after the pressurization processing, the booklet is ejected together with the sheet to the ejection unit. In this manner, the present embodiment can prevent a contaminant from sticking to the booklet, thus allowing creation of a high quality booklet. More specifically, pressurizing the booklet b by the pressurization roller 361 through the sheet 500 can prevent wrinkles from occurring on the booklet b. In addition, since the sheet 500 is introduced so as to cover the binding needles n of the booklet b in the pressurization processing, the binding needles n and the pressurization roller 361 do not directly contact with each other. By doing this, shavings of the binding needles n and transfer of a substance stuck to the binding needles n, such as grease, to the pressurization roller 361 can be prevented. Furthermore, the sheet 500 once used is ejected to the ejection unit 380, and a new sheet 500 is introduced onto a next booklet b. Thus, even when the introduced sheet 50 becomes contaminated, the contamination is not transferred to another booklet b.

### (Control Flow)

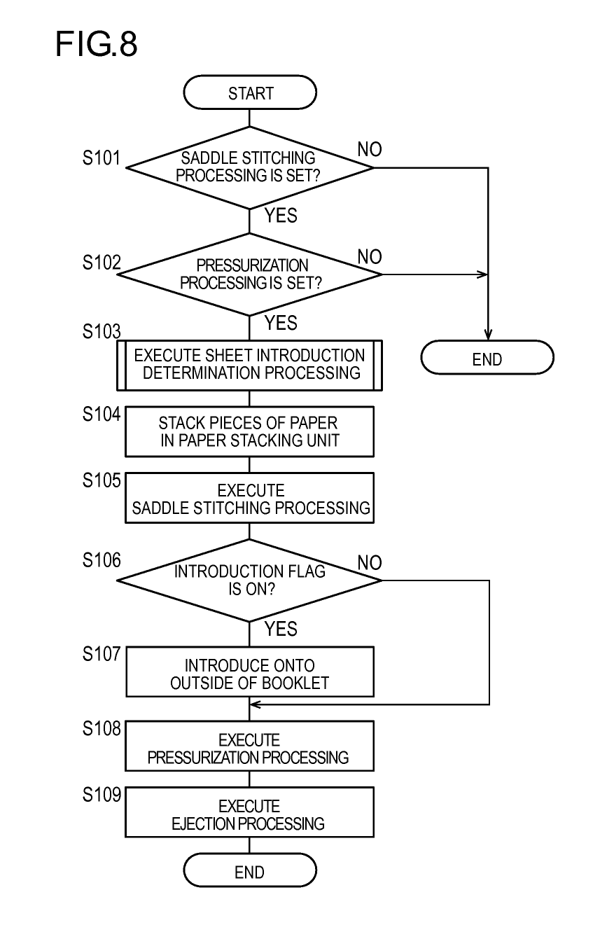

FIGS. 8 and 9 are flowcharts mainly executed by the control unit 310 of the post-processing apparatus 20. With reference to the drawings, a description will be given of sheet introduction processing in creating a booklet b in the present embodiment.

At a step S101 of FIG. 8, the control unit 310 determines whether or not the saddle stitching apparatus 300 is set to execute saddle stitching processing on paper ejected and conveyed from the image forming apparatus 100.

Then, when the apparatus 300 is set to execute saddle stitching processing (S101: YES), the control unit 310 determines at a subsequent step S102 whether or not pressurization processing is set to be executed.

When execution of pressurization processing is set (S102: YES), the control unit 310 executes sheet introduction determination processing of a subsequent step S103.

FIG. 9 is a flowchart showing a sub-routine of the step S103. At a first step S201, the control unit 310 determines whether the sheet introduction is set to “every execution” for executing the sheet introduction at all times from between “every execution” and “conditional execution”. When the sheet introduction is set not to “every execution” but to “conditional execution” (step S201: NO), introduction condition determination processing of the step S202 as described below will be executed.

### (S202: Introduction Condition Determination Processing)

Table 1 is an example of introduction conditions A to F for the introduction condition determination processing. The control unit 310 includes a sheet introduction condition setting means and a sheet introduction condition determining means (see FIG. 2). The sheet introduction condition determining means determines whether at least one of the introduction conditions A to F as shown in the Table below is satisfied or not. The introduction conditions A to F are managed by the sheet introduction condition setting means and held in the ROM or the memory 111 of the control unit 110. The user can perform switching between validity and invalidity of each of the introduction conditions A to F and changing of setting values for the conditions through the operation and display unit 120.

TABLE 1

| | Determination items | Criteria |
|---|---|---|
| A | Number of times of | not less than a |
| | pressurization processing | predetermined number |
| | (processing time) | of times |
| B | Number of copies after | not more than a |
| | staple cartridge | predetermined number |
| | replacement | of copies |
| C | Printing rate or density on | not less than a |
| | spine cover | predetermined |
| | | printing rate or a |
| | | predetermined |
| | | density |
| D | Temperature setting for | Low temperature |
| | fixing | setting |
| E | Type of paper | Specific type of paper |
| F | Set number of copies | every time when |
| | (Number of booklets) | reaching a set number |
| | | of copies |

“Introduction condition A” shown in the Table 1 is the number of times of pressurization processing per booklet (the number of times of pressurization). As described above, pressurization processing is performed by rotationally moving the pressurization roller 361 along the center portion c (fold) of a booklet b. The number of times of the processing given by default is two times as one-time reciprocation. However, the number of times of pressurization processing can be changed according to setting. For example, the number of times of the processing may be varied depending on a thickness of a booklet calculated according to the number of pieces and weight of paper forming the booklet, or may be set to a number of times of the processing fixed by the user. As the number of times of the processing increases, a bending angle of both sides of the spine b1 comes closer to a right angle and thus the appearance becomes better. On the other hand, productivity decreases, and also transfer of grease or toner onto the pressurization roller 361 easily occurs.

“Introduction condition B” is the number of copies printed after stable cartridge replacement, and the condition is determined to be satisfied when the number of copies is not more than a predetermined number of copies. A staple cartridge is attachable to and detachable from the saddle stitching apparatus 300. When the binding needles n contained in the cartridge are consumed and the cartridge becomes vacant, a signal for replacement is transmitted to the image forming apparatus 100. Based on the replacement signal, the image forming apparatus 100 displays a request for staple cartridge replacement. When the user replaces the staple cartridge with a new one, the control unit 310 resets a consumption counter. In some cases, there is grease stuck to a new staple cartridge, and thus much grease is highly likely to stick to the binding needles n used in a booklet b for a while after cartridge replacement. When the pressurization roller 361 directly contacts with binding needles n to which grease is stuck, the grease is highly likely to spread onto the spine b1 of the booklet b and stick thereto. Accordingly, the sheet 500 is introduced every time during a period of time from cartridge replacement to creation of a predetermined number of copies (for example, twenty copies).

“Introduction condition C” is a printing rate or density of an image formed on the spine cover that is an outer surface of the spine b1 of the booklet b after square spine shaping. Printing rate used herein refers to a ratio of an area of the image (pixels) to an area of the spine b1. In calculating the area of the spine b1, a width of the spine bl may be appropriately set from a thickness of a paper bundle for creating a booklet or may be set to a predetermined fixed value. Density refers to a maximum density, which is a maximum density of an image formed on a region that becomes the spine b1. When the printing rate or density is not less than a predetermined printing rate or a predetermined density, the condition is determined to be satisfied. As the amount of toner stuck to a region around the center portion c to be pressurized by the pressurization roller 361 is larger, the toner is easily transferred onto the pressurization roller 361.

Temperature setting for fixing as “Introduction condition D” refers to a fixing control temperature of a fixing unit of the image forming unit 130 of the image forming apparatus 100. A determination is made as to whether or not a temperature set for fixing is set to a lower temperature than a normal temperature setting. Fixing setting temperature is set depending on the type, weight, and the like of paper. As the fixing setting temperature is lower, an adhesive strength of toner stuck to the paper surface is lower, thereby causing the toner to be easily transferred onto the pressurization roller 361.

“Introduction condition E” is type of paper. In the case of a specific type of paper, the condition is determined to be satisfied. Information on the type of paper is held in the memory 111 of the image forming apparats 100, according to each paper storage unit 140. An example of a specific type of paper is embossed paper. Embossed paper has a surface with concave and convex portions formed thereon. Due to this, fixing by the fixing unit tends to be partially insufficient depending on the concave and convex portions. Thus, toner is easily transferred onto the pressurization roller 361.

“Introduction condition F” relates to a set number of copies, and the condition is determined to be satisfied every time when reaching a set number of copies. The set number of copies can be set through the operation and display unit 120 by the user. For example, in a setting of five copies, when 10 copies of the booklet b are consecutively created, the sheet 500 is introduced onto an initial first copy and a sixth copy but not introduced onto the other copies. The reason for this is as follows. In pressurization processing performed each one time on each booklet b, there are few foreign substances (such as toner, grease, and shavings) sticking to the pressurization roller 361. However, pressurization processing performed a plurality of times without introducing the sheet 500 causes accumulation of such foreign substances. Thus, the sheet 500 is introduced on a regular basis to clean up the pressurization roller 361. In this case, the sheet 500 highly effective in cleaning is preferably a nonwoven fabric sheet made of a material such as polyethylene, polypropylene, or polyethylene terephthalate or paper having a rough surface (rough paper).

As described above, the user can switch between validity and invalidity or change a condition value regarding each of the introduction conditions A to F, and the introduction conditions are managed by the sheet introduction condition setting means. The sheet introduction condition determining means of the control unit 310 performs a determination in order from the introduction condition A. Regarding an invalid introduction condition, determination is skipped, whereas regarding a valid introduction condition, a determination is made as to whether it is satisfied or not (S202). Then, when at least one of the introduction conditions is satisfied, the sheet introduction condition is determined to be satisfied (S203: YES).

When the determination at the step S201 or the step S203 is YES, an introduction flag is turned ON at the step S204, and a size of the sheet 500 to be introduced is determined on the basis of a size of paper forming a booklet or information of the paper size and binding positions of the binding needles n. After that, process returns to the flow of FIG. 8 (RETURN). A method for determining the size of the sheet will be described later.

Subsequently, at a step S104 of FIG. 8, the control unit 310 causes paper middle folded by the middle folding unit 330 to be stacked in the paper stacking unit 340. In addition, the paper stacking unit 340 also performs alignment processing for correcting a displacement between the plurality of stacked pieces of paper. At a next step S105, the saddle stitching unit 350 is caused to execute saddle stitching processing on the center portion of the stacked plural pieces of paper to create a booklet.

At a next step S106, a determination is made as to whether the introduction flag is ON or not. It is the introduction flag set at the step S103 (S204). When the introduction flag is ON (S106: YES), the sheet 500 is, at a next step S107, introduced onto the outside of the saddle stitched booklet b so as to cover the one or more binding needles n. As described above, the sheet 500 may be conveyed from the paper placement unit 230, or may be conveyed from any one of the paper storage unit 140.

At a step S108, the square spine shaping unit 360 performs pressurization processing (square spine processing). In this case, although the pressurization roller 361 pressurizes the center portion c of the booklet b, the pressurization roller 361, the binding needles n, and the center portion n do not directly contact with each other, since the center portion c including the binding needles n is covered with the sheet 500.

At a step S109, the conveyance unit 320 is caused to eject the booklet b to the ejection unit 380. When the sheet 500 is introduced at the step S107, the outside of the booklet b is covered with the sheet 500, and thus the booklet b covered therewith is ejected, as it is, to the ejection unit 380.

### (Method for Determining Size of Sheet 500)

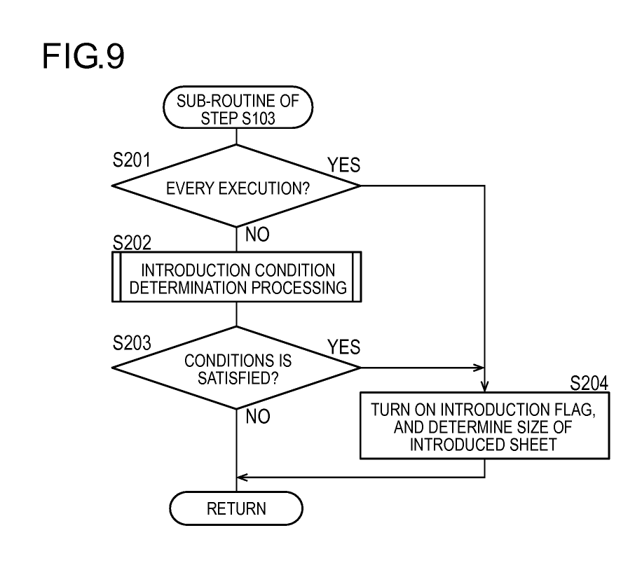

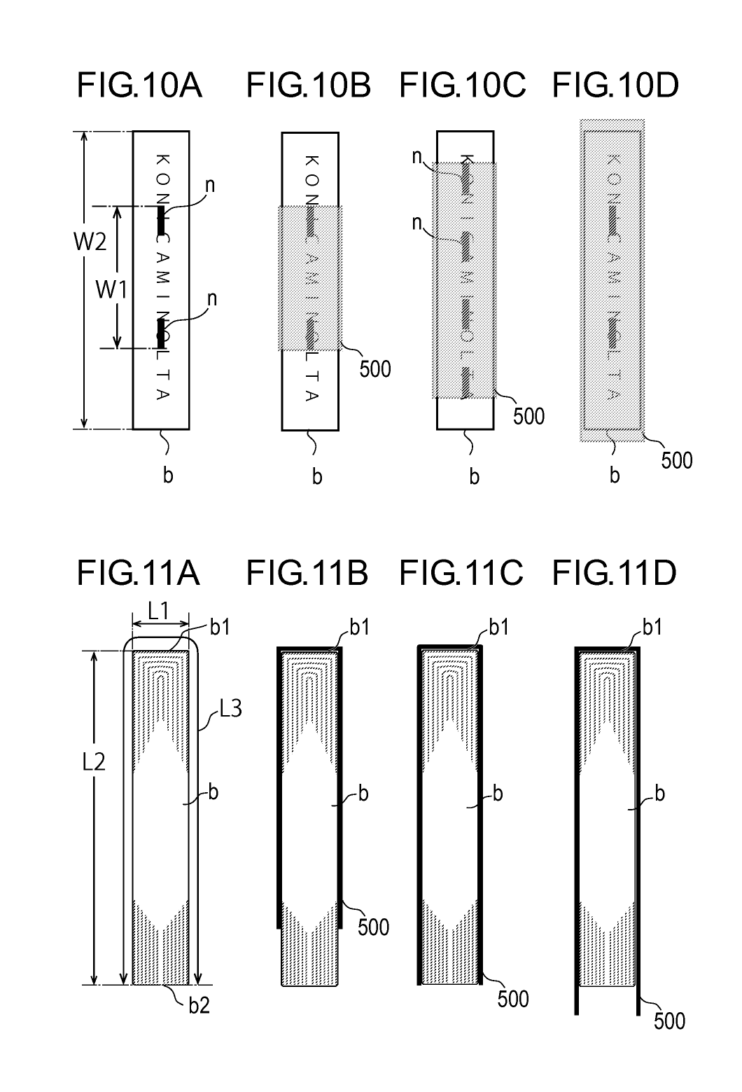

FIGS. 10A to 10D are schematic diagrams of the booklet b as seen from a spine b1 side, and FIGS. 11A to 11D are schematic diagrams of the booklet b as seen from a top side.

### (Widthwise Length)

First, a description will be given of a method for determining a widthwise length (hereinafter referred to simply as “width”) orthogonal to the conveying direction of paper, with reference to FIGS. 10A to 10D. FIG. 10A is a diagram showing a state of the booklet b before being covered with the sheet 500. W1 and W2, respectively, shown in the drawing represent a binding width that is a length between outer ends of outermost binding needles n and a width of the booklet b. Additionally, characters “KONICA MINOLTA” represent an image formed on the surface (the spine cover) of the spine b1.

FIGS. 10B to 10D show states of booklets b covered with sheets 500 having respectively different widths. The width of the sheet 500 can be of any length as long as it is long enough to be able to cover all of the binding needles n. FIGS. 10B and 10C are examples, in each of which the width of the sheet 500 is the same as a binding width W1. It can be seen that, in FIG. 10B, two binding needles n for binding at two positions on the booklet b and, in FIG. 100, all four binding needles n for binding at four positions thereon, respectively, are covered with the respective sheets 500 having widths W1.

The width of the sheet 500 is preferably the same as the width W2 of the booklet b, but can be either longer or shorter than the width W2 thereof as long as it is not less than the binding width W1. FIG. 10D is an example in which the width of the sheet 500 is longer than the width W2 of the booklet b.

The width of the sheet 500 can be set to various values according to a reference position for width alignment of the alignment mechanism of the stacking unit 340. In order to set the width of the sheet 500 to be the same as the binding width W1 of the booklet b, an alignment mechanism whose alignment reference is at the center position is needed. Thereby, the center position of the booklet b placed on the stacking unit 340 matches with the center position of the sheet 500, so that the sheet 500 having the width W1 can cover the binding needles n of the booklet b. On the other hand, the width of the sheet 500 may be set to be the same as the width W2 of the booklet b or longer than a width from one end to an outer position of a binding needle n on a most opposite side from the one end. Making the width of the sheet 500 longer than the above-mentioned width allows omission of such an alignment mechanism or sharing of an alignment mechanism for aligning paper forming a booklet b (herein, a mechanism for aligning widthwise one ends of pieces of paper).

### (Length in Conveying Direction)

Next, with reference to FIGS. 11A to 11D, a description will be given of a method for determining a length of the sheet 500 in a paper conveying direction. FIG. 11A is a diagram showing a state of the booklet b before being covered with the sheet 500. Reference sign b1 denotes spine, and reference sign b2 denotes fore edge. A length of the spine b1 of the booklet b is denoted by L1; a length of one of front and back covers is denoted by L2; and an entire length of cover paper forming covers of the booklet b is denoted by L3 (=L1+2×L2).

FIGS. 11B to 11D show states of booklets b covered with sheets 500 having respectively different lengths. The length of the sheet 500 in the conveying direction may be the same as, longer or shorter than the entire length of the cover paper. FIG. 11Bshowsastateofthe booklet b where the length of the sheet 500 is shorter than the entire length L3 of the cover paper. FIG. 11C shows a state of the booklet b where the length of the sheet 500 is the same as the entire length L3, and FIG. 11D shows a state of the booklet b where the length of the sheet 500 is longer than the entire length L3, respectively. In the first embodiment, since the fold of the sheet 500 middle folded in the middle folding unit 330 is placed so as to be superimposed on the fold (the center portion c) of the booklet b placed in the stacking unit 340, both are aligned on a center basis.

A lower limit length of the sheet 500 is the longest one among a length Li of the spine b1, a lower limit length that can be clamped by the clamping members 362, and a lower limit length that can be conveyed by the conveyance unit 320. As described above, while being covered with the sheet 500, the booklet b is ejected to the ejection unit 380. When the length of the sheet 500 is set to be shorter than the entire length L3 of the cover paper, there is an advantage in that the user can easily remove the sheet 500 from the booklet b ejected together with the sheet 500 to the ejection unit 380.

On the other hand, when the length of the sheet 500 is set to be longer than that, the sheet 500 can cover the booklet b including the covers thereof. Thus, there is an advantage in that during conveyance in the post-processing apparatus or off-line processing after passing the ejection unit 380, contamination on or damage to the covers of the booklet b can be prevented.

In FIGS. 11A to 11D, for simple illustration, there is shown a state where the fore edges b2 are straightly aligned. However, actually, the fore edges b2 do not become aligned due to a curvature difference between the inside and the outside of the paper bundle caused by middle folding. Accordingly, the cutting unit 370 in the post step performs cutting processing so that the fore edges b2 are straightly aligned. An upper limit length of the sheet 500 is preferably the same as the entire length L3 (FIG. 11C), but may be longer than the entire length L3 (FIG. 11D) if there is no influence on the cutting processing on the booklet b performed at the post-step.

### Second Embodiment

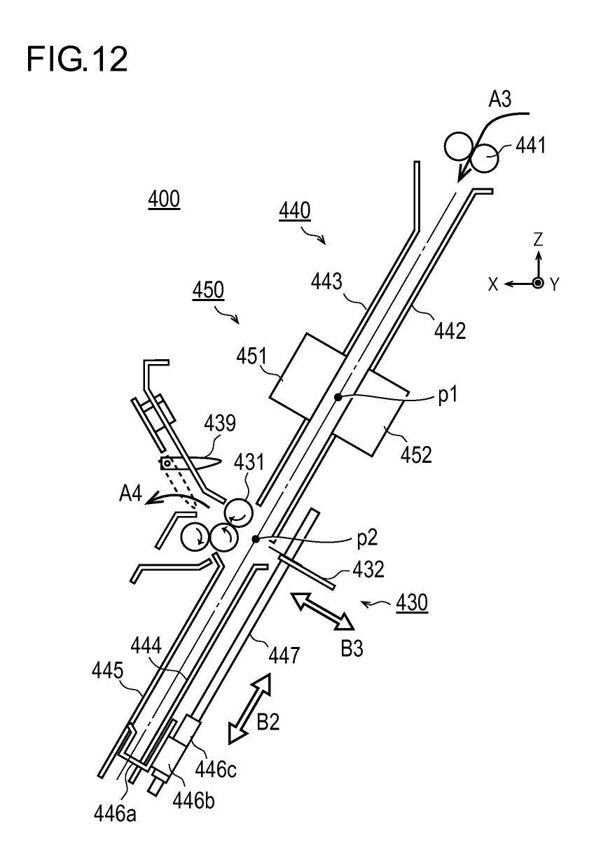

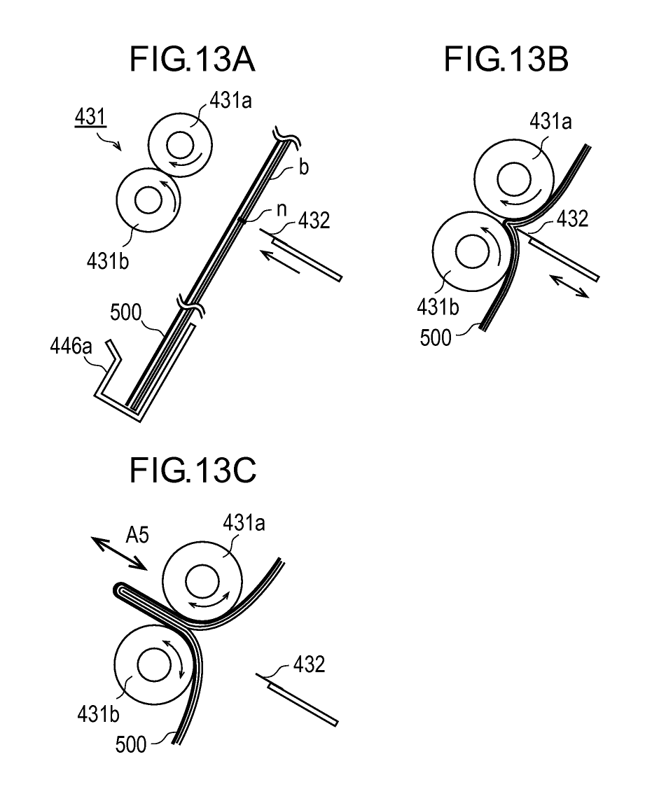

Next, a second embodiment of the invention will be described. FIG. 12 is a schematic diagram showing a structure of a saddle stitching apparatus 400 according to the second embodiment of the invention. FIGS. 13A to 13C are schematic diagrams illustrating middle folding processing by the saddle stitching apparatus 400. The saddle stitching apparatus 400 shown in those drawings includes a middle folding unit 430, a stacking unit 440, and a saddle stitching unit 450. Structures other than those shown in FIGS. 12 and 13A to 13C are the same as structures in the image forming system according to the first embodiment shown in FIGS. 1 to 4. In addition, even in the second embodiment, the control flow of FIGS. 8 and and the introduction condition determination processing exemplified in the Table 1 are applicable. Furthermore, while the square spine shaping unit 360 functions as the “pressurization unit” in the first embodiment, the middle folding unit 430 functions as the “pressurization unit” in the second embodiment to shape a booklet b.

In the second embodiment, stacking and alignment processing by the stacking unit 440, saddle stitching processing by the saddle stitching unit 450, and middle folding processing by the middle folding unit 430 are executed in this order, and these pieces of processing, respectively, correspond to the pieces of processing of the step S104, the step S105, and the step S108, in FIG. 8. The saddle stitching apparatus 400 will be described below with reference to FIG. 12 and FIGS. 13A to 13C.

The stacking unit 440 includes conveyance rollers 441 on an upstream side, guide members 442, 443, 444, and 445, a butting member 446a, a connection member 446b a sliding member 446c, and a rail 447. Paper conveyed from the upstream side (an arrow A3) is conveyed by the conveyance rollers 441 to be conveyed to a stacking region surrounded by the guide members 442, 443, 444 and 445 and the butting member 446a. The conveyed paper is stopped by butting a leading end of the paper against the butting member 446a. In the drawing, the Z direction indicates an upward direction in a gravity direction, and the conveyed paper receives gravity in a minus Z direction and falls. The conveyed pieces of paper are placed in order of conveyance in such a state that the leading ends thereof are butted against the butting member 446a along the guide members 442 and 444 inclined due to self-weights thereof. The plurality of pieces of paper conveyed and placed in the stacking region are also aligned in the Y direction by a not-shown widthwise alignment member.

The sliding member 446c is connected to a not-shown drive motor. The sliding member 446c and the butting member 446a are connected by the connection member 446b, and these members move in a direction of an arrow B2 along the rail 447.

The saddle stitching unit 450 comprises a needle driving mechanism 451 driving one or more binding needles n and a needle receiving mechanism arranged relatively with respect to the needle driving mechanism 451. All pieces of paper forming a booklet b are conveyed to and stacked in the stacking region. Then, after alignment processing is performed on the pieces of paper, the butting member 446a ascends by a predetermined amount along the rail 447 and stops. Thereby, a center portion of a bundle of the pieces of paper reaches a needle driving position p1 between the needle driving mechanism 451 and the needle receiving mechanism 452 of the saddle stitching unit 450. Following this, the saddle stitching unit 450 executes saddle stitching processing by driving one or more binding needles n into the center portion of the bundle of the plurality of pieces of paper, thereby creating a booklet b.

### (Middle Folding Unit 430)

The middle folding unit 430 includes folding rollers 431a and 431b, a folding blade 432, and a switching gate 439. As described above, in the second embodiment, the middle folding unit 430 functions as the “pressurization unit”. In addition, the pair of folding rollers 431a and 431b (hereinafter, the two rollers will be together referred to simply as “folding rollers 431”) function as “pressurization members”.

After the saddle stitching processing, the butting member 446a descends by a predetermined amount and stops, thereby the center portion (binding position) of the booklet b moves to a folding position p2. The folding position p2 is located on a straight line that connects a center position of a nip portion of the pair of folding rollers 431 and a leading end of the folding blade 432. The folding rollers 431 and the folding blade 432, respectively, structurally correspond to the folding rollers 331 and the folding blade 332, respectively, shown in FIG. 4.

After the booklet b is moved to such a position, the sheet 500 is conveyed for the booklet b. The sheet 500 may be conveyed from the paper placement unit 230, as with the first embodiment, or may be conveyed from any one of the paper storage units 140. The sheet 500 conveyed to the stacking region is introduced onto the outside (an upper surface) of the booklet b placed along the inclination of the guide members 442 and 444 in such a state that a leading end of the sheet 500 is butted against the butting member 446a. Thereby, an entire part or a part of the center portion of the booklet b and the binding needles n are brought into a state of being covered with the sheet 500. FIG. 13A shows the state.

Then, as shown in FIG. 13B, the folding blade 432 is protruded to the center portion of the booklet b perpendicularly to the paper surface of the booklet b from an obliquely downward direction to the folding rollers 431 in an obliquely upward direction. By doing this, the booklet b passes through the nip between the rotating folding rollers 431, with the center portion thereof ahead, whereby pressurization processing is performed. In this case, the booklet b, while being covered with the sheet 500, passes through the nip between the folding rollers 431. Thus, the folding rollers 431 and the one or more binding needles n of the booklet b do not directly contact with each other.

The booklet b subjected to middle folding processing is guided in a direction of an arrow A4 by the switching gate 439 to be ejected to the ejection unit 380 on the downstream side.

The folding roller 431a that is one of the folding rollers 431 is energized with constant pressure toward the nip portion by a spring or the like on a straight line that connects center axes of the folding rollers 431a and 431b, and are movable in a range of about a width corresponding to a thickness of the booklet b on the straight line. Additionally, the folding rollers 431 are rotatable in both of a forward direction and a reverse direction, as shown in FIG. 13C. The booklet b can also be caused to pass through the nip portion between the folding rollers 431 a plurality of times by reciprocating the center portion thereof in a direction of an arrow A5 in the nip portion. In addition, the number of times of pressurization for allowing the booklet b to pass therethrough may be set according to the thickness of the booklet b calculated from the number of pieces and weight of paper forming the booklet b. As the number of times of pressurization increases, the appearance of the fold of the booklet b becomes better.

Thus, even in the second embodiment, the sheet 500 is introduced so as to cover the one or more binding needles n and the near-center portion of the saddle stitched booklet b, and pressurization processing is performed by the folding rollers 431 through the sheet 500. Accordingly, the binding needles n and the near-center portion do not directly contact with the folding rollers 431. This can prevent contamination of the booklet b due to shavings of the binding needles n caused by contact with the folding rollers 431 and contamination of the booklet b due to spread of grease stuck to the binding needles n caused thereby. Additionally, the second embodiment can prevent the booklet b from becoming defective due to scraping or peeling of a toner image formed near the center portion by sliding of the toner image formed on the cover surface of the booklet b with respect to the folding rollers 431.

In the second embodiment, in the stacking region, the booklet b and the sheet 500 are butted against the butting member 446a to be stopped with the leading ends thereof in the conveying direction aligned. That is, the ends thereof serve as a reference. Accordingly, in order to cover the binding needles n driven into the center portion of the booklet b with the sheet 500, the sheet 500 can be of any size as long as it has a length not less than half the entire length L3 (see FIG. 11A) of the cover paper of the booklet b. More preferably, in order to performing a plurality of times of pressurization processing as shown in FIG. 13C, the size of the sheet 500 may be not less than a length obtained by further adding a peripheral length of the folding rollers to the half of the entire length L3.

While the present invention has been described with reference to some exemplary embodiments thereof, the main structures of the image forming system 10 and the post-processing apparatus 20 have been merely illustrated to describe features of the above respective embodiments and modifications, and the structures of the apparatuses are not limited to those described above. In addition, structures of a typical image forming system 10 and a typical post-processing apparatus 20 are not excluded.

Furthermore, although FIG. 5 and FIGS. 6A and 6B have shown the exemplary manner in which square spine shaping is performed by the pressurization roller 361 rotationally moving along the fold, this is merely one example. For example, square spine shaping may be performed by moving a plate-shaped pressurization member sufficiently longer than the length of the center portion c (Y direction) of the booklet b in the Z direction.

In addition, as shown in FIG. 2, the control unit 110 of the image forming apparatus 100 also has the functions of the sheet introduction condition setting means and the sheet introduction condition determining means. The control flow regarding sheet introduction of Figs. and 9, and the like has been executed by the control unit 310 of the post-processing apparatus 20. However, as an alternative to this, the control unit 110 of the image forming apparatus 100 may mainly execute the control regarding sheet introduction in cooperation with the control unit 310.

What is claimed is:

1. A post-processing apparatus comprising:
a conveyance unit for conveying paper conveyed from an image forming apparatus;
a paper stacking unit for stacking a plurality of pieces of paper;
a saddle stitching unit for saddle stitching a center portion of the plurality of pieces of paper stacked by the paper stacking unit by one or more binding needles to create a booklet;
a pressurization unit provided with a pressurization member, the pressurization unit performing pressurization processing on the booklet by pressurizing the center portion of the booklet saddle stitched by the saddle stitching unit by the pressurization member;
an ejection unit for ejecting the booklet subjected to the pressurization processing by the pressurization unit; and
a control unit for introducing a sheet onto an outside of the saddle stitched booklet so as to cover the one or more binding needles before pressurizing by the pressurization member, causing the pressurization member to perform the pressurization processing through the sheet, and, after the pressurization processing, causing the booklet together with the sheet to be ejected to the ejection unit.

2. The post-processing apparatus according to claim 1, wherein the sheet is paper conveyed from the image forming apparatus or paper conveyed from a sheet storage unit included in the own apparatus.

3. The post-processing apparatus according to claim 1, comprising a middle folding unit for folding the center portion of the paper conveyed by the conveyance unit, wherein
the saddle stitching unit performs saddle stitching on the plurality of pieces of paper middle folded by the middle folding member and stacked by the paper stacking unit; and
the pressurization unit is a square spine shaping unit including a pair of clamping members for clamping by clamping the middle folded and saddle stitched booklet from both sides, the square spine shaping unit flatly shaping a spine of the booklet by performing pressurization processing onto a fold of the booklet clamped by the clamping members by the pressurization member from a direction parallel to clamping faces of the clamping members.

4. The post-processing apparatus according to claim 1, wherein
the pressurization member is a pair of folding rollers, and
the pressurization unit is a middle folding unit for performing half-folding of the booklet by pressurization processing in which the saddle stitched booklet is caused to pass through between the pair of folding rollers, with the center portion thereof ahead.

5. The post-processing apparatus according to claim 1, wherein
the control unit is capable of selecting whether to set the introduction of the sheet onto the outside of the booklet to “every execution” for introducing the sheet onto all booklets or “conditional execution” for introducing the sheet when at least one predetermined condition is satisfied.

6. The post-processing apparatus according to claim 5, wherein
the control unit is capable of setting a number of times of the pressurization by the pressurization member when performing the pressurization processing, and determines whether the at least one predetermined condition is satisfied or not according to setting of the number of times of the pressurization.

7. The post-processing apparatus according to claim 5, wherein
the control unit determines whether the at least one predetermined condition is satisfied or not, on the basis of a replacement timing for a cartridge containing the binding needles.

8. The post-processing apparatus according to claim 5, wherein
the image forming apparatus is an electrophotographic image forming apparatus using toner, and
the control unit determines whether the at least one predetermined condition is satisfied or not, on the basis of at least one of printing rate on a spine cover of the booklet, toner fixing control temperature, and type of paper.

9. The post -processing apparatus according to claim 5, wherein
the control unit causes the sheet to be introduced for every set number of copies in a case of the conditional execution.

10. The post-processing apparatus according to claim 1, wherein
in a paper conveying direction, the sheet to be introduced has a length not less than a length of the paper forming the booklet.

11. The post-processing apparatus according to claim 1, wherein
in a paper conveying direction, the sheet to be introduced has a length shorter than a length of the paper forming the booklet.

12. The post-processing apparatus according to claim 1, wherein
in a width direction orthogonal to a paper conveying direction, the sheet to be introduced has a length not less than a length of the booklet.

13. The post-processing apparatus according to claim 1, wherein
in a width direction orthogonal to a paper conveying direction, the sheet to be introduced has a length shorter than a length of the booklet and not less than a length capable of covering all of the binding needles.

14. An image forming system comprising:
an image forming apparatus for forming an image on paper; and
the post-processing apparatus according to claim 1 for performing post-processing on paper conveyed from the image forming apparatus.

15. A post-processing method performed by a post-processing apparatus comprising a paper stacking unit for stacking a plurality of pieces of paper conveyed from an image forming apparatus, a saddle stitching unit for saddle stitching a center portion of the plurality of pieces of paper stacked by the paper stacking unit by one or more binding needles to create a booklet, a pressurization unit provided with a pressurization member for pressurizing the center portion of the booklet saddle stitched by the saddle stitching unit to perform pressurization processing on the booklet by the pressurization member, and an ejection unit for ejecting the booklet subjected to the pressurization processing by the pressurization unit, the post-processing method comprising:
introducing a sheet onto an outside of the saddle stitched booklet so as to cover the one or more binding needles before pressurizing by the pressurization member, causing the pressurization member to perform the pressurization processing through the sheet, and, after the pressurization processing, causing the booklet together with the sheet to be ejected to the ejection unit.
